(19) United States
(12) Patent Application Publication
(10) Pub. No.: US 2006/0203905 A1
(43) Pub. Date: Sep. 14, 2006

(54) Video coding system

(76) Inventor: Shih-Chang Hsia, Yuanlin Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/078,308

(22) Filed: Mar. 14, 2005

(51) Int. Cl. H04N 11/04; H04N 7/12; H04B 1/66; H04N 11/02

(52) U.S. Cl. 375/240.2; 375/240.24; 375/240.12

(57) ABSTRACT

The present invention relates to a video coding system, which particularly presents a new addressing method that uses the bit allocation approach to simplify the computational circuit and significantly improves the memory access speed. Additionally, a pseudo address decoding concept is taken in a new memory structure for the bit allocation requirement, which can reduce the I/O complexity and to shorten the access time, a memory IP integrated practically into the video coding system can also show a best real-time access and a novel comparison-cell that can do the comparison of n data at a time based on dynamic logic methodology to not only search speedily for vectors as requested, but also simplify a circuit size substantially. Then, the results of n-data are passed to the m-bit NAND gate for the final comparison, where m corresponds to the word length of each data. Compared with the conventional comparators, the number of transistors can be efficiently reduced and the circuit delay time is also shortened.

### BACKGROUND OF THE INVENTION

1. Field of the Invention

The present invention relates to a video coding system, and more particularly, to an apparatus and method for the memory design and the fast comparison circuit.

2. Brief Description of the Prior Art

The current video coding schemes employ the block-based motion estimation and compensation, wherein many memories must be employed. Block matching methods are popularly used to find the motion vector. Thus the block data controlling and addressing become more complex if more reference memories are adopted. How to access the frame memory for real-time operation and the fast comparison to find the motion vector is an important issue, particular for HDTV systems. Currently, the on-chip memory design becomes very popular for practical applications, but the system design complexity becomes very high.

For video processing, the frame data is partitioned into uniform blocks. In order to access the block data, the block position is found via the memory addressing. As the coding procedure goes on, the frame memory is updated with block-by-block. In order to achieve real-time work, the speed of the block address generation and the memory data access must be enough for the appropriate specification.

For memory access, there are the write address mode and the read address mode. In the write mode, two kinds of writing addresses are generated. One stores input pixels for the block-based processing. Hereafter, this memory is called as M1 later. The other updates the frame memory according to the motion vector, where the frame memory is called as M2. In the read mode, there are two-address generators at least. One is for reading the input pixel from M1. The others are for reading the reference frame data from M2 via the searching motion vector. If two reference frames are employed for bi-direction searching, two addresses are required to read reference memories. For real-time coding requirement, the above read/write operations must be finished in one cycle. The frame memory needs to use random access type due to blocks-based accessing. However, if this kind of memory with a single data port, we must separate the read cycle and the write cycle for data access. Thus read/write functions cannot operate in the same cycle. The memory cell accessing and its addressing speed must be reduced to a factor of ¼ since a single I/O port is employed. It is very difficult for high-speed access.

Generally, the memory bandwidth would affect the memory access time. When the image pixel uses 8-bit resolution, the memory access time can be given by

$${M}_{acess \text{-} time} = \frac{T \times {M}_{BW}}{8} , \\ T = \frac{1}{H \times V \times F} \qquad ( 1 )$$

where M_{BW} is the memory bandwidth, and T is the fixed time for data access in the specified format, H and V is the horizontal and vertical resolution respectively, F is the frame rate. If the memory data bandwidth is wider, we can admit longer access time for real-time processing. For example, 1920×1040 HDTV format with 60 Hz frame rate, the access time is only 8.4 ns when an 8-bit memory is employed. This is very challenge for real-time system realization. As the data width is expand to 32-bit, the memory access time only requires 8.4×4=33.6 ns to meet real-time operation. However, the interconnections between memory and computation core become more complex. “How to balance the memory bandwidth and the access time” is a key design point.

The typical memory structure is shown in FIG. 1. There are n rows and m columns to decode 2ⁿ×2^{m} addressing lines for accessing the internal cells. As this memory is applied to store the frame data, many memory cells would be wasted.

### SUMMARY OF THE INVENTION

Therefore, it is a main object of the present invention to provide a video coding system, which particularly presents a new addressing method that uses the bit allocation approach to simplify the computational circuit and significantly improves the memory access speed. Additionally, a pseudo address decoding concept is taken in a new memory structure for the bit allocation requirement, which can reduce the I/O complexity and to shorten the access time, a memory IP integrated practically into the video coding system can also show a best real-time access and a novel comparison-cell that can do the comparison of n data at a time based on dynamic logic methodology to not only search speedily for vectors as requested, but also simplify a circuit size substantially.

Then, the results of n-data are passed to the m-bit NAND gate for the final comparison, where m corresponds to the word length of each data. Compared to the conventional comparators; the number of transistors can be efficiently reduced and the circuit delay time is also shortened.

### BRIEF DESCRIPTION OF THE DRAWINGS

The foregoing aspects and many of the attendant advantages of this invention will be more readily appreciated as the same becomes better understood by reference to the accompanying detailed drawings, wherein:

FIG. 1 is a diagram of the conventional memory structure,

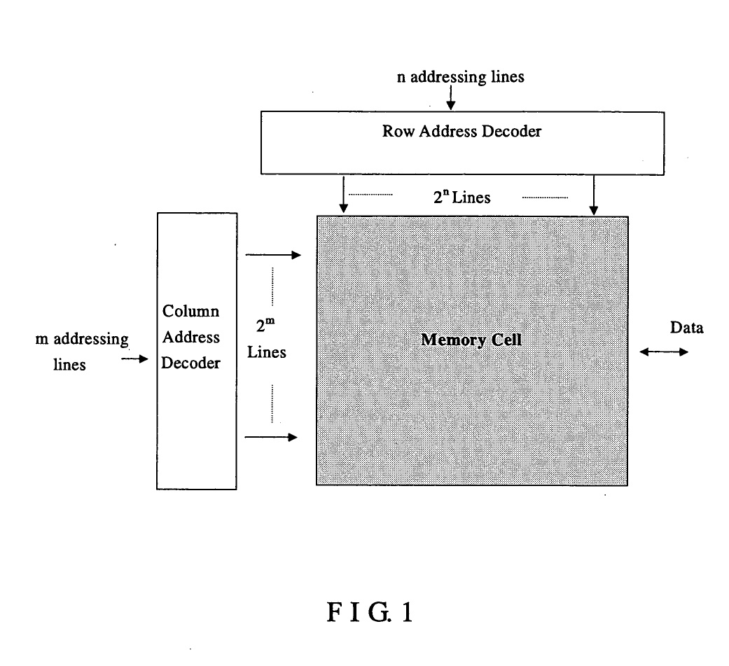

FIG. 2 is a diagram showing the corresponding addresses of the conventional macro block (MB) and sub-block (SB),

FIG. 3 is a diagram of the address generator with bit allocation method according to the present invention,

FIG. 4 is a diagram of the bit allocation with motion vector for reference macro block address according to the present invention,

FIG. 5 is a diagram of the new memory structure wit pseudo addressing design according to the present invention,

FIG. 6 is a flowchart of the pipe processing for each computational unit according to the present invention,

FIG. 7 is a diagram of the proposed memory IP used in the video coding system according to the present invention,

FIG. 8 is a diagram of the comparator implementation with cascade comparison cell,

FIG. 9 is a diagram of the comparison cell design with CMOS NAND and NOR gates according to the present invention,

FIG. 10 is a diagram of the proposed comparison-cell circuit according to the present invention,

FIG. 11 is a diagram of the comparison-cell expanded for the entire m-bit word comparison according to the present invention.

### DETAILED DESCRIPTION OF THE PREFERRED EMBODIMENTS

In order to make the illustration of the present invention more explicit and complete, the following description is stated with reference to the accompanying drawings.

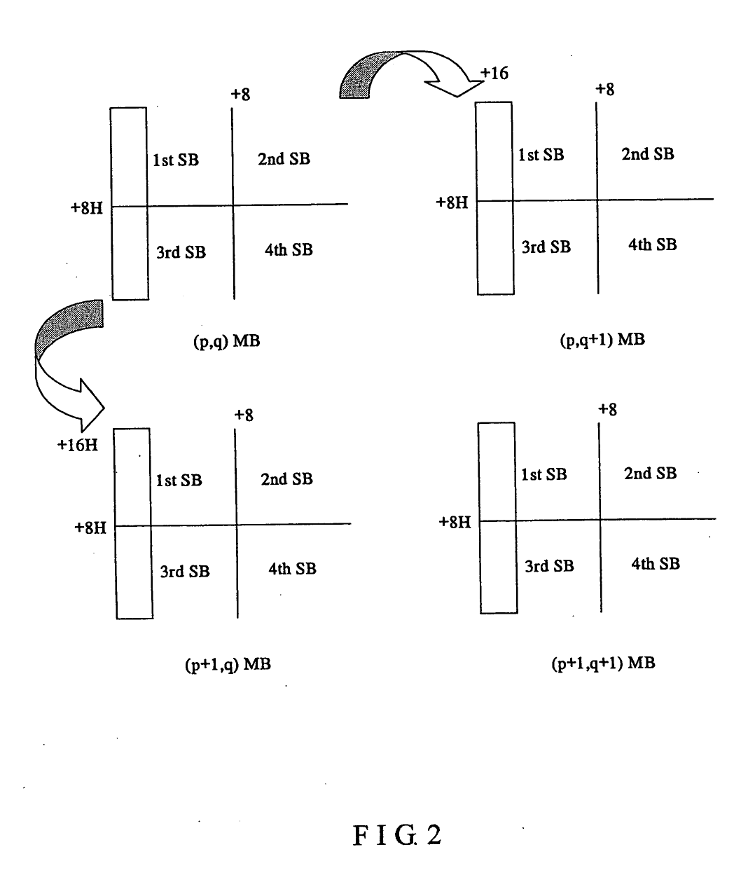

Referring to FIG. 2, the typical video coding system employs the hierarchical layer processing. The processing data can be spilt into GOB (Group of Block) layer (for H.261-x) or Slice layer (for MPEG-x), MB (Macro Block) layer and SB (Sub-Block) layer. One GOB or Slice layer contains several MBs, hereafter, GOB symbol is presented as a set of MBs. The size of MB uses 16×16 that is further split into four sub-blocks (SB). Each sub-block size is 8×8. The starting and ending code of each layer can directly address the range of memory. Using a hierarchical control, the addressing procedures are from GOB layer to sub-block one. The address of GOB layer can be generated by
GOB_{current}^{Addr}=GOBₚᵣₑᵥᵢₒᵤₛ^{Addr}+(16×16)×NO_{—}MB (2)
where the GOB_{current} ^{Addr} and GOBₚᵣₑᵥᵢₒᵤₛ ^{Addr} denotes the address of the current GOB and the previous GOB respectively, and NO_MB is the number of MB within one GOB.

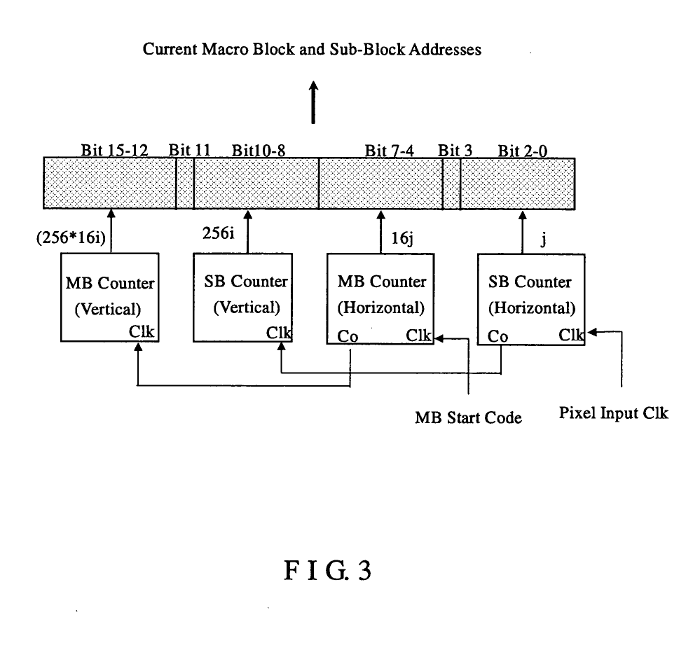

Referring to FIG. 3, the second layer is the MB address generator and the macro block address increases by 16 as MB starting code is confirmed. Until to the most right boundary, the macro block address increases by 16 H, where H is the number of samples per horizontal line; then, the macro block of the next column is encoded. Since some macro blocks are possibly skipped during inter frame coding, the macro block address increases by 16×S, where S denotes the number of macro block skipped. Therefore, the MB address can be determined by
MB_{(p,q)}^{Addr}=GOB_{current}^{Addr}+p×16 H+(q+S)×16 (3)

where (p,q) is the position of MB. Furthermore, one macro block can be split into four sub-blocks. The address increases by one when one pixel inputs. And the address increases by H values when the block position changes to the next column. Successively, the address of bottom blocks (3^{rd} and 4^{th} SB) is equal to the sum of the top block address and 8 H. From the above mention, each sub-block address can be expressed as
SB_{—}1st_{(i,j)}^{Addr}=MB_{(p,q)}^{Addr}+i×8+j,
SB_{—}2nd_{(i,j)}^{Addr}=MB_{(p,q)}^{Addr}+i×8+j+8,
SB_{—}3rd_{(i,j)}^{Addr}=MB_{(p,q)}^{Addr}+i×8+j+8×H,
SB_{—}4th_{(i,j)}^{Addr}=MB_{(p,q)}^{Addr}+i×8+j+8×H+8, (4)

for 1^{st}, 2^{nd}, 3^{rd} and 4^{th} sub-block address generation respectively, where(i,j) is the pixel location in each sub-block.

For motion estimation, the block processing uses MB base. The searching memory address can be determined by
MB_{(My,Mx)}^{Addr}=MB_{(p,q)}^{Addr}=My×H=Mx (5)

where Mx and My are the searching vector in the horizontal and vertical directions respectively. The vector would be a positive or a negative number. The computational complexity for motion pixels accessing becomes more complex. For real-time applications, each pixel address must be completely computed within one cycle. Computing the vector address for motion estimation becomes a critical path that will determine the maximum delay time in the memory addressing.

To compute Eqs.(2)-(5), two multiplications and eighteen additions are required.

Referring to FIG. 3, a bit-allocation approach is presented rather than address computations in order to reduce the circuit complexity. At first, the frame size uses a 2ⁿ×2^{m} format and the bit allocation for addressing the macro block (MB) and the sub-block (SB), where the vertical address counters and the horizontal address counters are employed. In the 256×256 format, the macro block address can be got from the combination of a 4-bit horizontal address counter with bits 7-4, and a 4-bit vertical address counter with bits 15-12. When the horizontal address counter increases by one, the macro block address increases by 16 because of allocating in the bits 7-4. As the counter reaches at 15, this denotes the current MB position at the most right side. Going to the next clock, the horizontal counter is reset to zero and the vertical counter is increased by one. Thus the macro block address increases by 16 H, now the processing block changes to the next column. With the same concept, bits 3-0 and bits 11-8 are employed for allocating the horizontal and vertical addresses of sub-block, where the bit 3 and the bit 11 respectively controls the address of the left/right SB and the top/bottom SB. Using this way, most of computations can be neglected, where the core size can be reduced and the operation frequency speed can be promoted.

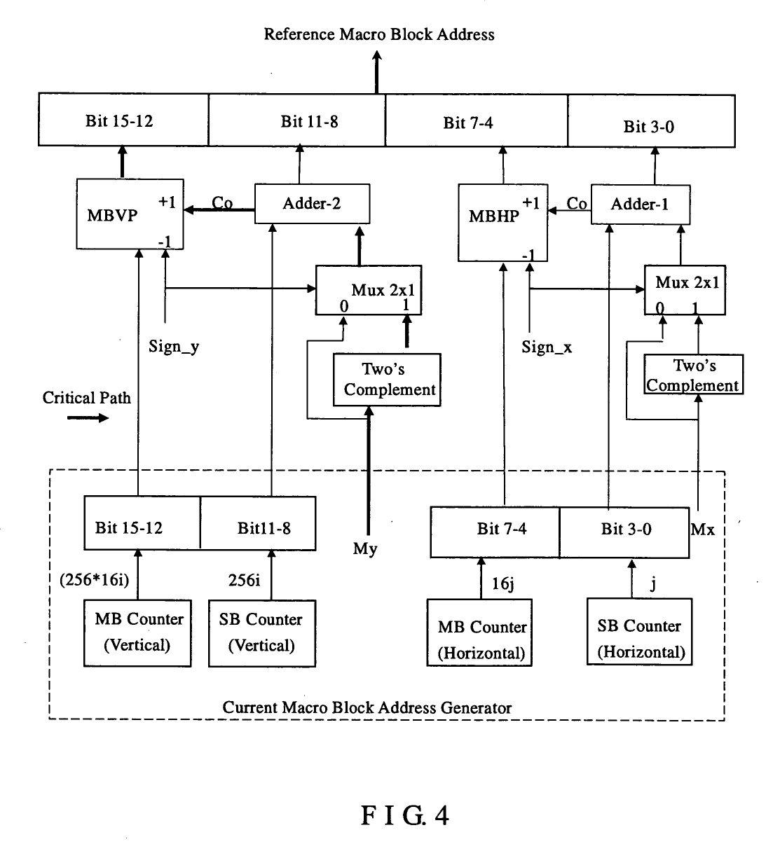

Referring to FIG. 4, the encoder performs motion estimation for searching the best matching between the current and the reference blocks of frame memory. The reference macro-block address can be attained from the addition of the current processed macro-block address and its relative search vector. Thus, it indicates that the bit allocation for the reference memory address generator according to the relative motion vector. The search algorithms decide the motion displacement from the current macro block with motion vector Mx, My and its sign-bits sign_x and sign_y. Because the motion vector may be a negative value, the extra processing is required for the negative vector. When sign_x=1 that is a negative horizontal vector, the horizontal vector can be attained from the addition of the two's complement of Mx and the current macro block address. The processed macro block position possibly moves to the previous or next one dependent on the searching vector. The macro block address can be controlled by the macro block horizontal (MBH) modular. As the carry-bit (Co) of adder is high, MBH increases by one in order to access the next MB data. However, MBH decreases by one as sign_x is high, such that the processing position moves to the previous MB.

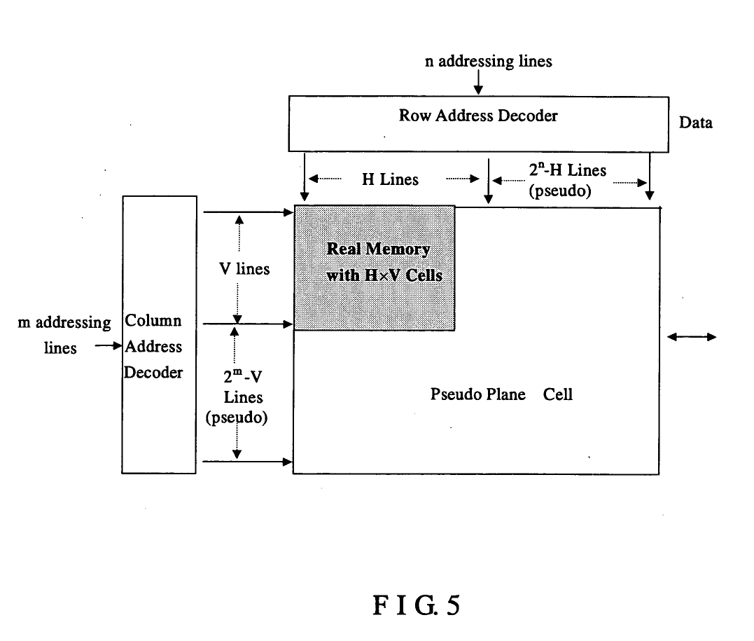

Referring to FIG. 5, a new memory structure includes the address decoder and storage cells that can be separately implemented in order to make the bit allocation applied to all different video sizes. The decoder locates the cell address through the decoding lines. For cost-effective design, only the used lines are decoded for the internal cell access. If the frame size is H×V, the n and m addressing lines are individually decoded to H lines and V lines rather than 2^{n+m} decoding lines. The memory address also has (n+m) pins, but only H and V decoding lines are implemented to access internal cells. The practical memory cells are implemented to meet the real frame size. Clearly we only use H×V cells, where 2^{n+m}−H×V space is a pseudo plane that don't require to be implemented. With this approach, one can save (2ⁿ−H)+(2^{m}−V) address decoding circuits and 2^{n+m}−H×V internal cells. The hardware complexity could be largely reduced. Now the cell size is equal to the real frame size, no memory cells are wasted. According to the above, this memory structure can be directly applied to bit-allocation addressing techniques.

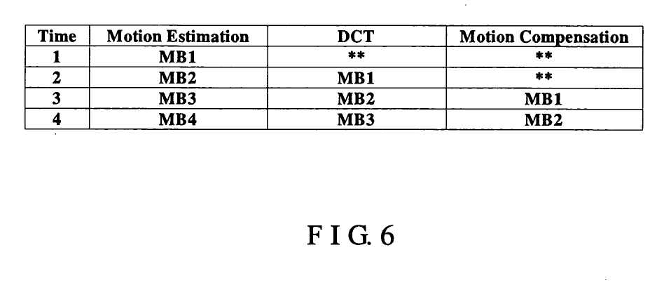

Referring to FIG. 6, it illustrates the pipeline processing flow for each computational unit. For real-time operation, the video coder needs to execute one pixel per cycle. In the MC-DCT coding system, all computing engines (motion estimation, DCT/IDCT, VLC . . . ) have to be active in every cycle in order to meet. real-time requirement. Definitely, the frame memory and its addressing control are required in system-level designs. Thus, a pipelined schedule could be employed for real-time processing. In the first time, the motion estimation for MB1 block is performed, where other MBs are idle. As motion vector of MB1 is found, the DCT processor can transform the differential values of input pixel (from M1 memory) and the reference frame (from M2 memory) in the second time. At the same time, MB2 is processed in the motion estimation engine. In the third time, the DCT coefficients of MB1 could be performed by quantization and de-quantization procedures. Then, the pixels are reconstructed from IDCT, and written into the frame memory for motion compensation. Simultaneously, the motion estimation for MB3 and DCT transformation for MB2 are fulfilled.

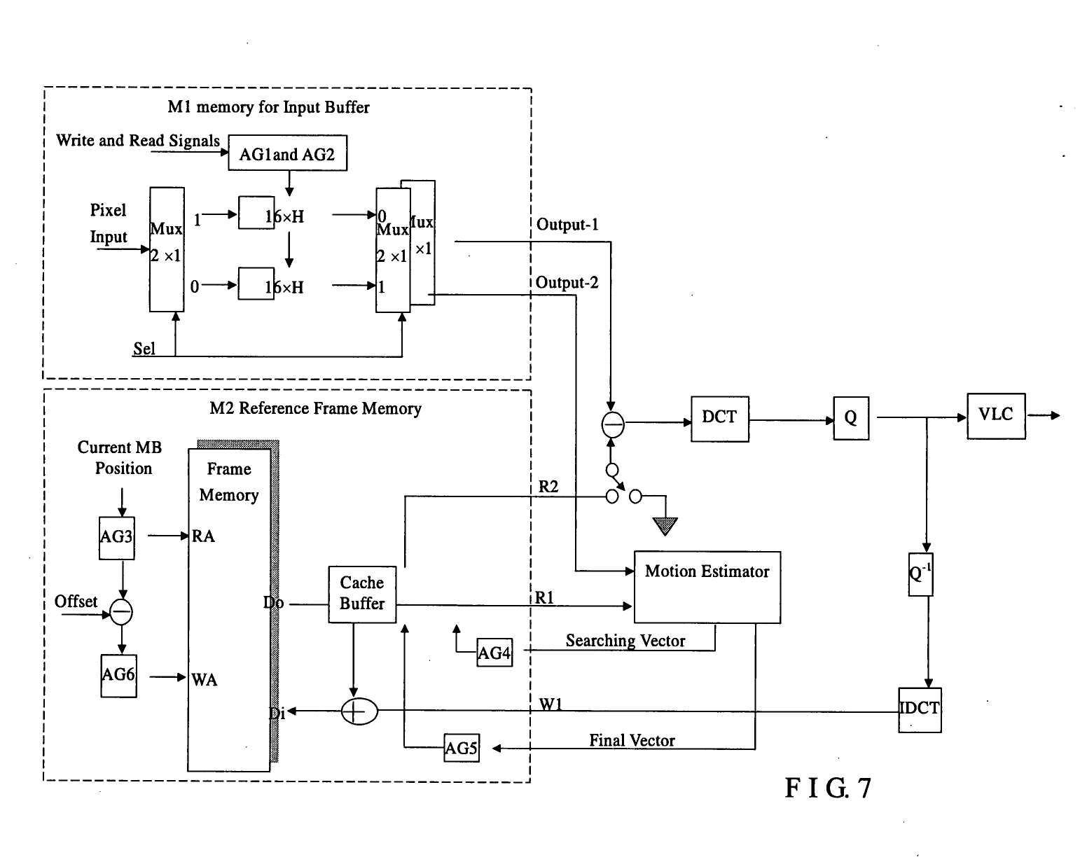

Referring to FIG. 7, it illustrates the use of the memory of the invention in video coding system (MC-DCT). The input memory M1 has one input and two output ports. The output-1 is for DCT transformation and the output-2 for motion estimation. The “write” address AG1 is used for storing the pixel input, and “read” address AG2 for reading the current processing pixel. For the real-time requirement, M1 memory is split into two banks, one for input and the other for output. As the size of macro-block is 16×16, each bank needs 16×H words, where H is the horizontal resolution. Two banks are executed with interlaced operations for real-time data access.

In the frame memory M2, there are 2 output ports as R1 for motion estimation and R2 for DCT transformation, and one input port as W1 for motion compensation. The system control sends the current MB position to the memory IP. Then one can find the corresponding memory address from the address generator AG3 that generates the MB address for motion estimation. As the coding procedures go on, the frame memory needs to be updated to the current frame with block-by-block according to motion vector.

But the previous frame data in the memory would be lost. To overcome this problem, the partial data of the previous frame needs to download to a cache buffer in order to keep the previous frame information for the motion estimation. The motion estimator can send the searching vector to the cache buffer. The cache buffer size depends on the searching range. With the address generator AG4, the cache buffer outputs the estimated data from the R1 port. The motion search finds the best block matching between the input memory and the cache memory. During a period of searching time, the final motion vector can be found from the motion estimator. This vector is given to the address generator AG5. From AG5, the frame data from R2 port output to DCT processor. The differential result of the input pixel and the best matching block is taken by DCT transformation. Finally, the motion compensation data is got from the addition of the previous frame block (from cache buffer) and the frame differential values (from inverse DCT). Then the frame memory is updated with the motion compensated data from the input port W1. The core of frame memory is designed with dual ports having one input and one output ports. The output port Do is read to the cache buffer with the AG3 address, and the input port Di is written to the frame memory with the AG6 address. For full encoding system design, the proposed memory system that includes the frame memory core, cache buffer, input buffer, addressing circuit, and other read/write control can be integrated as a memory IP for advanced SOC design. The system controller only assigns the current MB position, searching vector and final vector to this memory IP. Because all addresses have the timing correlation, the address for each memory bank can be generated from address generators in the memory IP self. Thus the cost-effective memory IP can be provided with low I/O bound, and high-efficiency SOC system design for video coding.

This invention also presents a digital comparator of the multi-input data computing for motion estimation. Assumed that there are n data, and each data has m bits, the circuit can do the comparison function at a time with a parallel architecture. When all input bits have the same value, the comparison circuit outputs become high; on the contrary, the outputs become low. The basic comparison function can be implemented with NXOR operation.

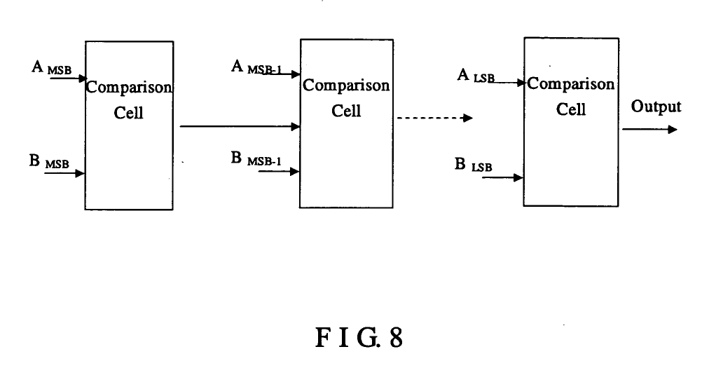

Referring to FIG. 8, a cascade comparison method is used to compare two input data from MSB to LSB and when each bit has the same level, the compared output is high. For the comparisons of multi-datum, it is necessary for users to compare one-by-one. Thus, the delay time thereof becomes long, so it is not appreciated for high-speed systems.

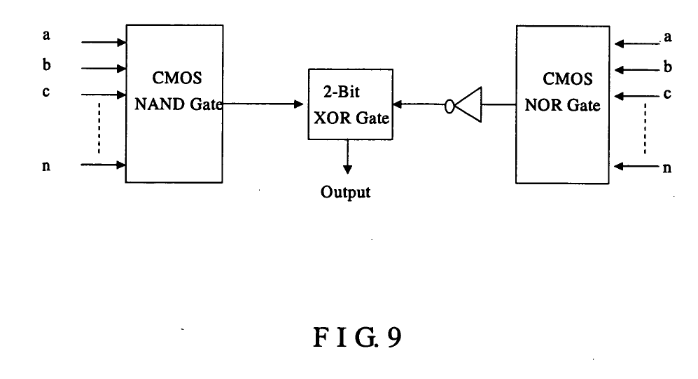

Referring to FIG. 9, the NAND and NOR gates can be applied to individually check whether the m^{th} bit of the input data is high or low. If the input bits show high and low respectively, the NAND and NOR gate outputs low and high, correspondingly. The outputs of NAND and the inversion of NOR send to a 2-bit NXOR gate. If the NOR gate outputs high, it denotes that the m^{th} bits of mutli-word are equal since all inputs are zeros. To realize such a comparison cell with CMOS circuit, the NAND gate and NOR gate needs 2n transistors respectively if there is n data. Moreover one 2-bit NXOR gate and one inverter gate used 12 transistors. Thus, the total number of cells requires 4n+12 transistors for one bit comparison. As the comparison for an entire word, the total cells will increase m-times transistors at least while each data has m bits.

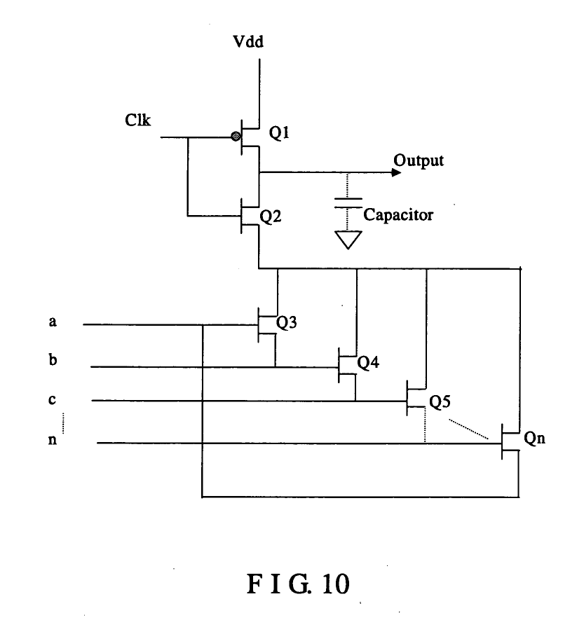

In order to reduce the cell complexity, a novel comparison circuit is designed by the MOS clocking-charge approach based on dynamic logic. Referring to FIG. 10, the comparison cells can be made by means of making the source S of PMOS Q1 connected to the drain D of NMOS Q2 to form an output terminal; the gate G of PMOS Q1 can be the input terminal of the clock signal (clk) and connected to the gate G of NMOS Q2; then, the source of NMOS Q2 are connected to n NMOS Q3˜Qn, and the gate G of the next NMOS can be linked to the source S of the last NMOS to form an input terminal; the source S of the final NMOS Qn is linked to the gate G of the first NMOS Q3. Accordingly, it can be a preferred comparator having n input terminals; in addition, the said output terminal is linked a pseudo capacitor together.

Further, the pseudo capacitor comes from the gate capacitor of the next stage input. While the clock signal (clk) is low, PMOS Q1 turns on, where the pseudo capacitor is charged to VDD. In such a case, NMOS Q2 turns off, so all inputs and output are isolated. While the clk signal becomes high, PMOS Q1 turns off and NMOS Q2 turns on. If all input signals (a,b, . . . n) are low, the NMOS Q3˜Qn all turns off, hence the capacitor voltage remains high. If all input signals are all high, the capacitor voltage is still high level since there are no discharge loops. Otherwise, as the input logic is different, at least one NMOS Q3˜Qn is turned on, so the output level becomes low due to the capacitor discharging to the turned-on NMOS. For example, when input (a,b,c,d)=(1011), Q3 is turned on, the discharge path is from Q2, Q3 to b. In the same way, users check all cases that the output becomes low if input logic levels are different. With the clock-charge structure, a comparison cell only requires (n+2) transistors. Moreover, the power dissipation shall be very low because there are no loops between the power and ground in any time. As for reducing the power dissipation further, the system can control the clock signal to become idle when the comparator is not used during some periods. Therefore, the clocking-charge comparison cell is very appropriated for low-power portable systems.

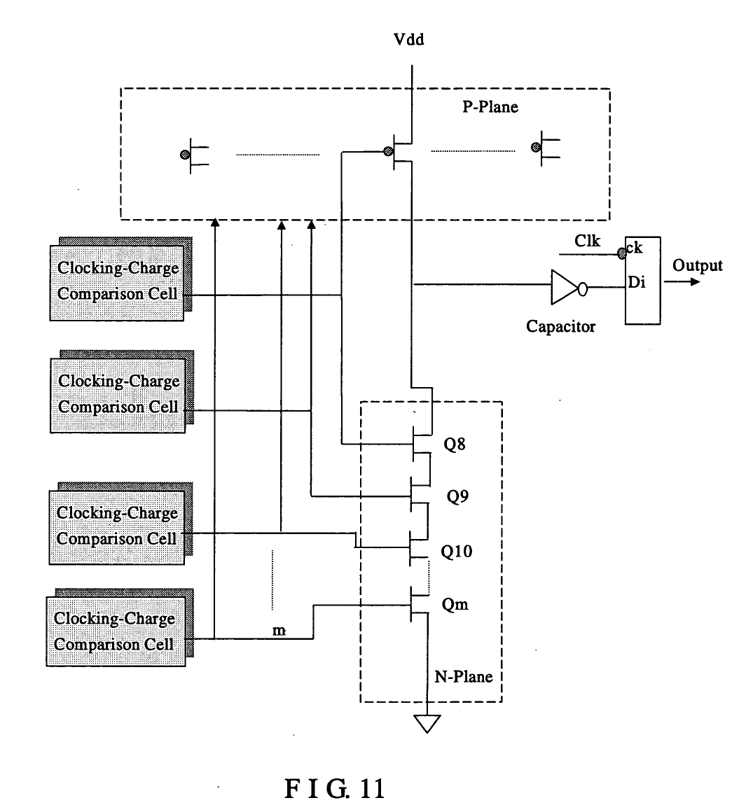

Referring to FIG. 11, the proposed cell can be easily expanded to meet any specification for comparing multi-data. If there is n data to be compared, one can check whether the m^{th} bit of all data is equal to the proposed comparison cell. As the entire word has m bits, the result of each comparison cell is sent to an m-bit CMOS NAND gate. The clocking-charge comparison-cells output their results to the NAND gate. If any input bit is unequal, the compared result is low. Clearly the NAND gate outputs high while any one input is low. If all input datum are equal, the results of comparison cells output high. In such a case, the CMOS NAND gate outputs low. While the expected output is high and the compared value is equal, an inverter cell is required to invert the logic level of NAND output. Finally, the D-type Flip- Flop (DFF) is used to latch the result with negative edge trigger to obtain a stable logic status. Since a clocking-charge comparison cell requires (n+2) transistors, the circuit needs (n+2)×m transistors for comparing m-bit word length. Moreover, the CMOS NAND gate, inverter and DFF requires 2m, 2, 16 transistors, respectively. Thus the total comparison circuit needs (mn+4m+18) transistors for comparing n datum with the m-bit resolution. With the proposed comparison cell, the multi-input datum can be compared at a time and the circuit delay time can be reduced accordingly.

From the above description, it can be understood that the present invention has advantages as followings:
1. The bit allocation approach thereof can be used to simplify the computational circuit and improves the memory access speed.
2. The new memory structure having the address decoder and storage cells for bit allocation addressing techniques can reduce the hardware complexity largely and the cell size thereof is equal to the real frame size so that no memory cells are wasted.
3. Six address generators being integrated practically thereto can promote real-time accessing of addresses as well as shorten the access time.
4. The comparison cell can carry out the comparisons of n datum at a time based on the dynamic logic methodology in order to search speedily for the vectors as required and simplify the circuit substantially.

What is claimed is:

1. A video coding system, comprising
a memory addressing method partitioning the frame data into uniform blocks, and the frame memory accessed with block-by-block;
a hierarchical layer processing employed with macro-blocks and sub-blocks and the starting and ending code of each layer capable of directly addressing the range of memory.
some macro-blocks are possibly skipped during inter frame coding, the macro block address increases by 16×S, where S denotes the number of macro-block skipped.

2. One macro block can be split into four sub-blocks. The address increases by one when one pixel inputs. And the address increases by H values when the block position changes to the next column. Successively, the address of bottom blocks (3^{rd} and 4^{th} SB) is equal to the sum of the top block address and 8 H.
The encoder performs motion estimation by the function which searches the best matching between the current and the reference blocks of frame memory. The searching memory address can be determined by MB_{(My,Mx)}^{Addr}=MB_{(p,q)}^{Addr}+My×H+Mx, where Mx and My are the searching vector in the horizontal and vertical directions respectively.

3. The video coding system as claimed in claim 1, further comprising the bit allocation method, the frame size of which uses a 2ⁿ×2^{m} format. Further comprising as the 256×256 format, the macro block address can be got from the combination of a 4-bit horizontal address counter with bits 7-4, and a 4-bit vertical address counter with bits 15-12. When the horizontal address counter increases by one, the macro block address increases by 16 because of allocating in the bits 7-4. As the counter reaches at 15, this denotes the current MB position at the most right side. Going to the next clock, the horizontal counter is reset to zero and the vertical counter is increased by one. Thus the macro block address increases by 16 H, now the processing block changes to the next column. Bits 3-0 and bits 11-8 are employed for allocating the horizontal and vertical addresses of sub-block, where the bit 3 and the bit 11 respectively controls the address of the left/right SB and the top/bottom SB. The addressing method for other 2ⁿ×2^{m} formats can be applied the similar method above.

4. The video coding system as claimed in claim 2, wherein the reference macro-block address can be attained from the addition of the current processed macro-block address and its relative search vector. The search algorithms decide the motion displacement from the current macro block with motion vector Mx, My and its sign-bits sign_x and sign_y. Because the motion vector may be a negative value, the extra processing is required for the negative vector. When sign_x=1 that is a negative horizontal vector, the horizontal vector can be attained from the addition of the two's complement of Mx and the current macro block address. The processed macro block position possibly moves to the previous or next one dependent on the searching vector. The macro block address can be controlled by the macro block horizontal (MBH) modular. As the carry-bit (Co) of adder is high, MBH increases by one in order to access the next MB data. However, MBH decreases by one as sign_x is high, such that the processing position moves to the previous MB. The reference macro block address is equal to the combination of the horizontal and vertical address values.

5. A video coding system, comprising
A memory structure having the pseudo address decoder and internal storage cells capable of separately being implemented; the sizes of pseudo address decoder and internal storage cells fitting in with the actual frame size; the used lines decoded only for the internal cell access.
The frame size is H×V, and the n and m addressing lines are individually decoded to H lines and V lines rather than 2^{n+m} decoding lines. The memory address has (n+m) pins, but only H and V decoding lines are implemented to access internal cells.
The practical memory cells are implemented to meet the real frame size. (2ⁿ−H)+(2^{m}−V) address decoding circuits and 2^{n+m}−H×V internal cells can be saved while inputting 2^{m}−V and 2ⁿ−H pseudo address lines. 2^{n+m}−H×V space is a pseudo plane that doesn't require to be implemented.
The pseudo address decoding is suitable for non-2ⁿ×2^{m} video format in claim 3. Change a non-2ⁿ×2^{m} video format to 2ⁿ×2^{m} video format with pseudo address decoding.

6. A video coding system with the apparatus for interface to apply the new memory addressing, comprising
The memory addressing control, address decoder and internal storage cell capable of being merged into one body as a memory core to implement full video encoder; the system includes six address generators (AG1˜AG6); the internal storage cell being consisted with input memory M1 and frame memory M2.

7. The video coding system as claimed in claim 6, further comprising the timing schedule. MB1, MB2 . . . are continuous macro-blocks. For real-time processing, a pipelined schedule could be employed. In the first time, the motion estimation for MB1 block is performed, where other MBs are idle. As motion vector of MB1 is found, the DCT processor can transform the differential values of input pixel (from M1 memory) and the reference frame (from M2 memory) in the second time. At the same time, MB2 is processed in the motion estimation engine. In the third time, the DCT coefficients of MB1 could be performed by quantization and de-quantization procedures. Then the pixels are reconstructed from IDCT, and written into the frame memory for motion compensation. Simultaneously, the motion estimation for MB3 and DCT transformation for MB2 are fulfilled.

8. The video coding system as claimed in claim 6, further comprising two kinds of memory used, one is the input memory M1, and the other is the frame memory M2. The input memory as buffer function is required for block-based processing. The ports of M1 memory contain one input and two outputs. The output-i is for DCT transformation and the output-2 is for motion estimation. The “write” address AG1 is used for storing the pixel input, and “read” address AG2 for reading the current processing pixel. For the real-time requirement, M1 memory is split into two banks, one for input and the other for output. As the size of macro-block is 16×16, each bank needs 16×H words, where H is the horizontal resolution. Two banks are executed with interlaced operations for real-time data access.

9. The video coding system as claimed in claim 6, wherein there are 2-output ports as R1 for motion estimation and R2 for DCT, and one input port as W1 for motion compensation in the frame memory, and the system control sends the current MB position to the memory IP; then, the corresponding memory address from the address generator AG3 generates the MB address for motion estimation. As the coding procedures go on, the frame memory needs to be updated to the current frame with block-by-block according to motion vector. The partial data of the previous frame needs to download to a cache buffer in order to keep the previous frame information for the motion estimation. The motion estimator can send the searching vector to the cache buffer. The cache buffer size depends on the searching range.
The cache buffer outputs the estimated data from the R1 port the with address generator AG4, The motion search finds the best block matching between the input memory and the cache memory. Then, the final motion vector can be found from the motion estimator. This vector is given to the address generator AG5.

10. The video coding system as claimed in claim 8, wherein the address generator AG5 can read the frame data via R2 port and those frame data can input to DCT processor then. The differential result of the input pixel and the best matching block is taken by DCT transformation.
The motion compensation data is got from the addition of the previous frame block (from cache buffer) and the frame differential values (from inverse DCT).

11. The video coding system as claimed in claim 8, wherein the frame memory is updated with the motion compensated data from the input port W1.
The video coding system as claimed in claim 8, wherein the kernel of frame memory is designed with dual ports that has one-input and one-output ports. The output port Do is read to the cache buffer with the AG3 address, and the input port Di is written to the frame memory with the AG6 address.

12. The video coding system as claimed in claim 8, wherein there are two blocks delaying between input and output in the frame memory. The write address (WA) could easily find from the read address (RA) added the offset value.

13. A video coding system, comprising
A novel comparison-cell capable of doing the comparison of n-data is at a clock time.
The NAND and NOR gates can be applied to individually check whether the m^{th} bit of the input data is high or low. If the input bits show high and low respectively, the NAND and NOR gate outputs low and high, correspondingly. The outputs of NAND and the inversion of NOR send to a 2-bit NXOR gate. If the NOR gate outputs high, it denotes that the m^{th} bits of mutli-word are equal since all inputs are zeros.
The NAND gate and NOR gate are all used with COMS transistors and needs 2n transistors respectively if there is n data. Moreover one 2-bit NXOR gate and one inverter gate used 12 transistors. Thus, the total number of cells requires 4n+12 transistors for one bit comparison. As the comparison for an entire word, the total cells will increase m-times transistors at least while each data has m bits.

14. The video coding system as claimed in claim 13, wherein a comparison circuit is presented by with a MOS clocking-charge approach.
The comparison cells can be made by means of making the source S of PMOS Q1connected to the drain D of NMOS Q2 to form an output terminal; the gate G of PMOS Q1 can be the input terminal of the clock signal (clk) and connected to the gate G of NMOS Q2; then,
the source of NMOS Q2 are connected to n NMOS Q3˜Qn, and the gate G of the next NMOS can be linked to the source S of the last NMOS to form an input terminal; the source S of the final NMOS Qn is linked to the gate G of the first NMOS Q3. Accordingly, it can be a preferred comparator having n input terminals; in addition, the said output terminal is linked a pseudo capacitor together. A comparison cell only requires (n+2) transistors.

15. The video coding system as claimed in claim 14, wherein the pseudo capacitor comes from the gate capacitor of the next stage input. Based on dynamic logic methodology, the pseudo capacitor can be pre-charged before circuit evaluation.

16. The video coding system for comparisons as claimed in claim 14, while the clock signal (clk) is low,PMOS Q1 turns on, where the pseudo capacitor is charged to VDD. In such a case, NMOS Q2 turns off, so all inputs and output are isolated. While the clk signal becomes high, PMOS Q1 turns off and NMOS Q2 turns on. If all input signals (a,b, . . . n) are low, the NMOS Q3˜Qn all turns off, hence the capacitor voltage remains high. If all input signals are all high, the capacitor voltage is still high level since there are no discharge loops. Otherwise, as the input logic is different, at least one NMOS Q3˜Qn is turned on, so the output level becomes low due to the capacitor discharging to the turned-on NMOS.

17. The video coding system as claimed in claim 16, wherein there are no loops between the power and ground in any cycle, such that less power can be consumed. While there is no motion made by the power and ground simultaneously, the clock signal (clk) shows a high level to form a power descending mode.

18. The video coding system as claimed in claim 16, wherein several comparators can be assembled together in order to make higher definitions. Further speaking, m comparison-cells are connected respectively to each gate G of NMOS and PMOS and the drain D of the next NMOS can be linked to the source S of the last PMOS; then, the drain D of the first NMOS can be connected to the source S of PMOS. Additionally, there are n data to be compared, and one can check whether the m^{th} bit of all data is equal with the proposed comparison cell. As the entire word has m bits, the result of each comparison cell is sent to an m-bit CMOS NAND gate.

19. The video coding system as claimed in claim 16, wherein an inverter cell is required to invert the logic level of NAND output. The D-type Flip-Flop (DFF) is used to latch the result with negative edge trigger to obtain a stable logic status. The video coding system as claimed in claim 18, the circuit needs (n+2)×m transistors for comparing m-bit word length.

20. The comparison can be applied on motion estimation to find the motion vector. Also, applied on the fast computing such data sorting, data searching, pattern comparison and pattern recognition. The circuit can compare m-data in parallel processing. The processing speed is very fast and it is suitable complex comparison system, such as biological technology.
